(19) United States
(12) Patent Application Publication
(10) Pub. No.: US 2007/0224003 A1
(43) Pub. Date: Sep. 27, 2007

(54) Subterranean chamber encapsulation system

(76) Inventor: Lawrence M. Janesky, Seymour, CT (US)

Correspondence Address: PERMAN & GREEN, 425 POST ROAD, FAIRFIELD, CT, 06824, US

(21) Appl. No.: 11/385,370

(22) Filed: Mar. 21, 2006

(51) Int. Cl. B32B 15/08; E02D 19/00

(52) U.S. Cl. 405/270; 52/169.14

(57) ABSTRACT

A partially subterranean chamber sealing system for sealing at least a partially subterranean chamber of a building is provided. The system comprises a flexible liner disposed on at least a portion of a surface bounding the chamber for forming a seal boundary of the chamber. The liner has a peripheral edge sealed to the surface lined by the liner for insulating the surface from the chamber. The flexible liner comprises a sealing layer and a radiant barrier disposed on the sealing layer.

### BACKGROUND

1. Field

The exemplary embodiments disclosed herein relate to a subterranean chamber encapsulation system and, more particularly, to a subterranean chamber encapsulation system with a radiant barrier.

2. Brief Description of Related Developments

Basements or crawlspaces may allow moisture and water vapor, for example, from dirt or concrete floors, to enter the building structure located above the space causing multiple problems, such as insect infestation or structural problems. A solution exists to provide a lining over the inside of the crawl space where the lining provides a vapor barrier between the dirt floor or vapor source and the structure to isolate the structure from the high humidity environment. One such system is disclosed in U.S. Pat. No. 6,575,666 which is incorporated by reference herein in its entirety. A problem arises when there is a temperature difference, for example between the building's crawlspace and the outdoors, where energy efficiency is lost. Accordingly, there is a desire to provide a lined crawlspace that minimizes energy loss due to heat losses.

### SUMMARY OF THE EXEMPLARY EMBODIMENTS

In accordance with one exemplary embodiment, a partially subterranean chamber sealing system for sealing at least a partially subterranean chamber of a building is provided. The system comprises a flexible liner disposed on at least a portion of a surface bounding the chamber for forming a seal boundary of the chamber. The liner has a peripheral edge sealed to the surface lined by the liner for insulating the surface from the chamber. The flexible liner comprises a sealing layer and a radiant barrier disposed on the sealing layer.

In accordance with another exemplary embodiment, a partially subterranean chamber sealing system for sealing at least a partially subterranean chamber of a building is provided. The system comprises a flexible liner having first and second high density layers. A reinforcing layer is disposed between the first and the second high density layers. A bonding layer is disposed between the first and the second high density layers. A reflective layer is adhered to either the first or second high density layers. The flexible liner is durable to repeatedly support a user walking or crawling thereon without tearing or breaking through the flexible liner. The bonding layer bonds the first and second high density layers together with the reinforcing layer disposed there between. The high density layers are adapted to prevent air or water vapor from passing there through. The reflective layer is adapted to reflect heat radiated thereon.

In accordance with another exemplary embodiment, a partially subterranean chamber sealing system for sealing at least a partially subterranean chamber of a building is provided. The system comprises a seal barrier disposed on at least a portion of the chamber for forming a sealed chamber with the seal barrier being flexible and conformal in shape so as to substantially conform to an uneven floor or wall of the chamber. A seal is disposed between at least a portion of the seal barrier and at least a portion of the chamber. The seal is adapted to seal the seal barrier to the chamber. The seal barrier comprises a sealing layer. A radiant barrier is connected to the seal barrier. The seal is adapted to prevent air or water vapor from passing there by. The seal barrier is adapted to prevent air, water or vapor from passing there through. The radiant barrier is adapted to reflect a substantial portion of radiated heat.

### BRIEF DESCRIPTION OF THE DRAWINGS

The foregoing aspects and other features of the exemplary embodiments are explained in the following description, taken in connection with the accompanying drawings, wherein:

FIG. 1 is a side elevation view of a building shown partially in cross-section with a partially subterranean chamber of basement and sealing system incorporating features in accordance with an exemplary embodiment;

FIG. 2 is a section view of the sealing system in the basement shown in FIG. 1;

FIG. 3 is a partial section view of a flexible liner of the system in FIG. 1;

FIG. 4 is a side elevation view of partially subterranean chamber and sealing system in accordance with another exemplary embodiment; and

FIG. 5 is another side elevation view of another partially subterranean chamber and sealing system in accordance with still another exemplary embodiment.

### DETAILED DESCRIPTION OF THE EXEMPLARY EMBODIMENT(S)

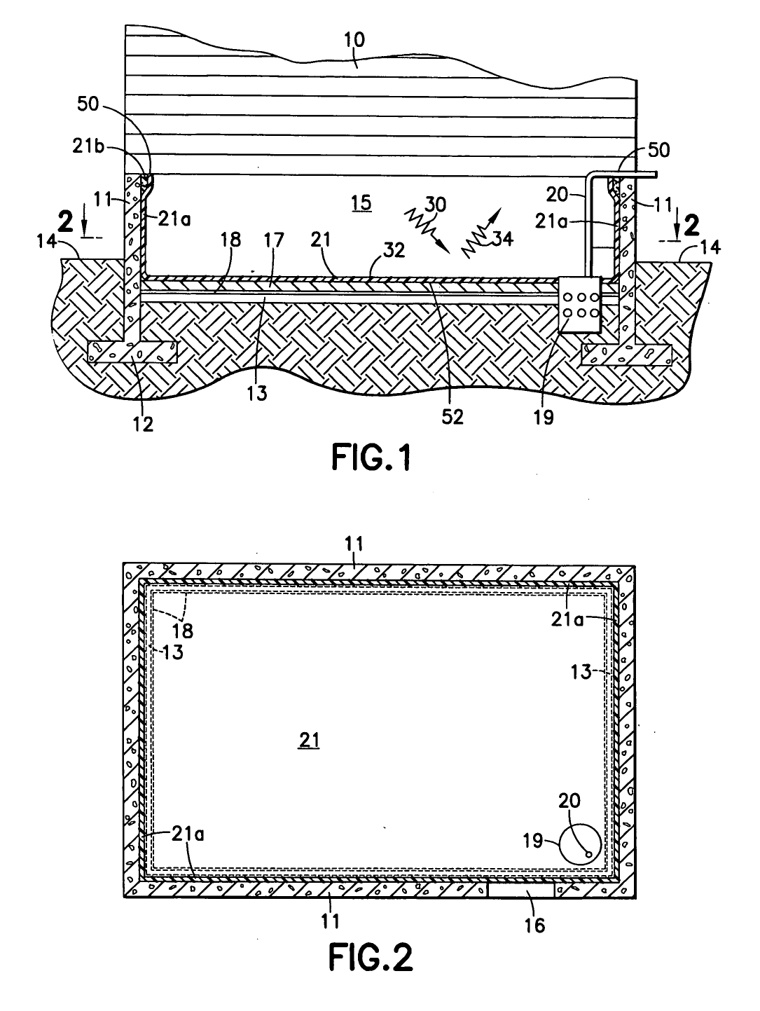

Referring to FIG. 1, there is shown, side elevation view of a building shown partially in cross-section incorporating features in accordance with an exemplary embodiment. Although the embodiments will be described with reference to the embodiments shown in the drawings, it should be understood that the present invention can be embodied in many alternate forms of embodiments. In addition, any suitable size, shape or type of elements or materials could be used.

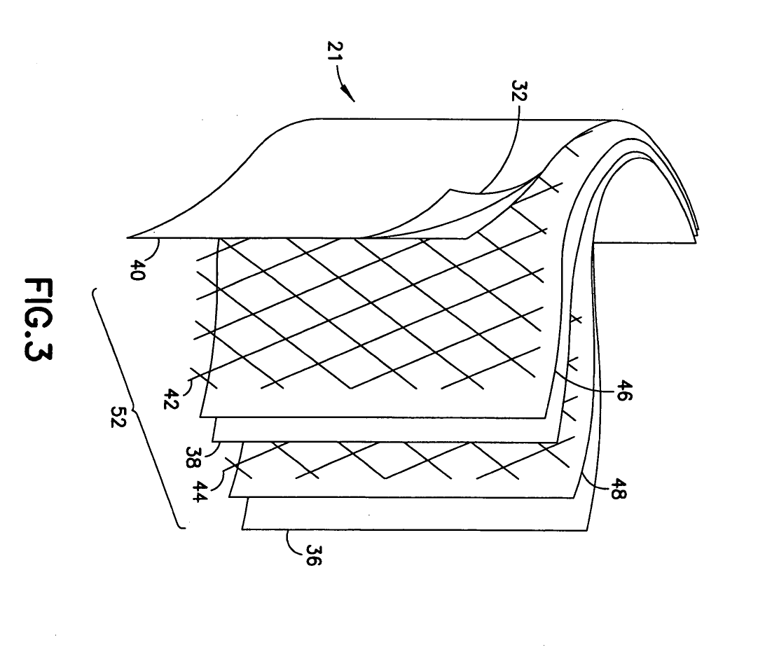

Referring now to FIG. 1, a building 10 such as a house is illustrated supported upon peripheral foundation walls 11 such as concrete block walls on a peripheral footing 12 buried in the ground beneath the frost line. The foundation walls 11 form a partially subterranean chamber, such as a crawlspace or basement. Also, an access opening 16, shown in FIG. 2, may be provided in the foundation 11, above ground level. Alternately, a hatch door may be provided in the roof or ceiling to permit access into the crawlspace when necessary. Any air vents present in the crawlspace walls 11 or foundation may be sealed or covered with a flexible crawlspace liner or otherwise as air circulation may not be desired after the crawlspace is sealed. Floor 17 of the crawlspace may be poured concrete, or may be a dirt floor. In alternate embodiments the crawlspace floor may be provided with an inner peripheral water drainage trench 18 or tile filled with aggregate and may contain a perforated water drainage conduit. The trench may open to a sump pit which, depending upon the slope of the terrain, may contain a sump pump (not shown) and a discharge pipe 20 (shown in phantom in FIG. 1 and representing the sump pump connected thereto) which extends up and over the foundation and drains to an external location whenever the water level of the sump pit rises to the activation level of the sump pump. The sump pump may be a conventional lever-activated sump pump. In the exemplary embodiment, a pit or void 19 may be formed in the crawlspace floor 17. The pit 19, which may be excavated through the existing floor may not have a pump or reservoir or pipe 20. Pit 19 may have a drain and alarm system, such as disclosed in co-pending U.S. patent application Ser. No. 11/342,404 filed Jan. 30, 2006 which is incorporated by reference in its entirety, adapted for use with, for example, a flexible crawlspace liner 21 encapsulating the crawlspace and sealing floor 17 or other seal barrier sealing the floor. Here, the drain and alarm system may be sealed to flexible liner 21 and may also prevent air, water or vapor to pass from the floor side of liner 21 to the building side of liner 21.

In the embodiment shown, chamber 15 may be substantially sealed or encapsulated with flexible liner 21, that is disposed to form a sealed barrier on at least a portion of a surface 17 bounding chamber 15 for forming a seal boundary 21b of chamber 15. Liner 21 comprises a seal barrier that is flexible and conformal in shape so as to substantially conform to a surface(s) of chamber 15, such as an even or uneven floor or inner surface of peripheral foundation wall of chamber 15. Flexible liner 21 may comprise a substantially continuously sealed liner lining peripheral foundation walls 11 and floor 17 bounding chamber. In alternate embodiments, liner 21 may cover only portions of chamber 15, for example, only floor 17 or only walls 11. In the exemplary embodiment shown, the liner has a peripheral edge 50 sealed to surface 11 an lined by the liner for insulating surface 11, 17 from chamber 15. Flexible liner 21 comprises a sealing layer 52 and radiant barrier 32 disposed on sealing layer 52. In the embodiment shown, seal 21b is disposed between at least a portion of seal barrier 21 and at least a portion of chamber 15 with seal 21b being adapted to seal the seal barrier to chamber 15. Sealed edge 50 is located proximate the top of peripheral walls 11. Seal 21b and seal barrier 21 are adapted to prevent air, water or vapor from passing there through. Radiant barrier 32 is adapted to block the flow of radiation there through. For example, radiant barrier 32 may comprise a thin layer of reflective material, such as aluminum, reflecting about 95% of radiant energy that strikes its surface and absorbing about 5%. In alternate embodiments, other suitable materials may be used. Here, radiant barrier 32 provides additional heating efficiency, for example during winter months, by allowing building 10 to retain radiant energy more effectively as the aluminum prevents the heat radiation from penetrating the surface covered and reflects back heat, for example to building 10. In alternate embodiments, liner 21 may also be provided with an insulating layer, for example, fiberglass or an air filled layer giving additional efficiency gains, such as by preventing the conduction of heat through liner 21. Flexible liner 21 is sufficiently durable to repeatedly support a user walking or crawling thereon without tearing or breaking through the flexible liner. Radiant barrier or reflective layer 32 is adapted to reflect a substantial portion of heat radiated thereon. Here, liner 21 extends over and seals the crawlspace floor, and may also have portions 21a extending over and sealing other portions of the crawlspace boundaries, such as the foundation walls. In alternate embodiments, the liner may have any desired shape. For example, the partially subterranean chamber sealing system having flexible liner 21 may be supported by an uneven floor surface with a peripheral edge of liner 21 sealed on wall portion 11 of the crawlspace offset from floor 17. In still other embodiments, any suitable vapor barrier such as a sealed concrete floor may be used to encapsulate the chamber in combination with liner 21. In the embodiment shown, continuous sealed crawlspace liner 21 is provided, such as of plastic film, which may be a monofilm, for example, approximately 16 mil thick durable heavy duty, fiber-reinforced multi-ply plastic film or rubber sheeting. In the embodiment shown, flexible liner 21 is provided with a reflective layer 32 for reflecting 34 radiant energy 30 incident on liner 21. The crawlspace liner 21 may be, for example, an integral continuous durable water barrier film or laminate or may be formed of wide strips of such film or laminate, such as about six feet in width, which are overlapped and sealed along the edges thereof with the waterproof caulk or adhesive or adhesive tape to provide a continuous sealed barrier liner 21 of the required dimensions. The crawlspace liner 21 may be installed over the dirt floor 17 and over the sump pit 19, if present, and may be extended vertically-upwardly to the tops of the crawlspace walls. As noted before, the liner 21 may be sealed against the inner surface of the foundation walls 11 peripherally surrounding and enclosing the crawlspace. The liner 21 may be sufficiently durable to resist tearing and piercing under the weight of the installers. The upper surface of the liner may be substantially white in color to brighten the crawlspace. The vertical peripheral crawlspace liner extensions 21a are extended and supported against the inner surfaces of the foundation walls 11 and sealed thereto at an elevation which is above the exterior ground level, for example, to the tops of the foundation walls. The continuous marginal liner extensions 21a are sealed or bonded to each other and to the entire peripheral inner wall of the foundation 11 adjacent the top thereof, for example, by use of an adhesive tape or a continuous bead 21b of suitable adhesive or caulk composition such as a polyurethane composition. Nylon fasteners may be used to support the liner 21 vertically over the foundation 11 during installation and prior to caulking. The crawlspace liner 21 and its extended marginal border areas 21a prevent the entry of water vapor from the soil or ground into the crawlspace environment and prevent external ground water or flood water entry into the crawlspace and on top of the crawlspace liner 21, over the dirt floor 17, where it can become trapped and stagnant and can generate mold and fungus and water vapor which can deteriorate and rot structural wood support members of the building 10. Any exterior ground water which might penetrate the foundation 11, such as through a cement block wall, is trapped beneath the liner extensions 21a and flows down into the dirt floor of the crawl space and into the drain tile channel 18, if present. This keeps the head space 15 of the crawlspace, or the crawlspace environment, dry. Thus, the installed crawlspace liner may totally encapsulate the crawlspace environment and completely isolates the building envelope and upper living spaces from the earth there below and from the dampness, insects and radon contained therein, to provide a healthier home environment.

Referring now to FIG. 3, there is shown a partial section view of flexible liner 21 incorporating features in accordance with an exemplary embodiment. In the embodiment shown, flexible liner 21 is shown having seven layers with one of the layers having additional reflective properties. In alternate embodiments, flexible liner 21 may have more or less layers. In alternate embodiments, liner 21 may have more reflective layers on different surfaces, or may have a reflective layer on a different surface. In the embodiment shown, flexible liner 21 has a seal barrier that has high density layers 36, 38, 40 with reinforcing layers 42, 44 disposed between high density layers 36, 38, 40. Bonding layers 46, 48 are disposed between the high density layers. Here, the bonding layers 46, 48 bond the high density layers 36, 38, 40 together with the reinforcing layers 42, 44 disposed there between. Reflective layer 32 is disposed on and adhered to high density layer 40. In the embodiment shown, radiant barrier 32 comprises a laminate of metal foil either metallized or adhered to the sealing layer 52, for example to one of the high density layers. Reflective layer or radiant barrier 32 may comprise one or more aluminum foil type layers laminated to the outer surface of layer 40. Additionally, a plastic layer may be further laminated over layer 32, for example, a clear polyester layer may be provided to prevent removal of the aluminum or oxidation of the aluminum or otherwise. The foil layer 32 may be bonded directly to layer 40, and may, for example be about 0.0002″ to 0.0005″ thick. Layer 32 may be bonded using any suitable adhesive. In alternate embodiments, other thickness or materials may be provided, for example, the foil may be about 0.002″ thick or otherwise; as a further example, layer 32 may comprise a reflective plastic coating. The aluminum layer may alternately be vapor deposited directly to layer 40. In alternate embodiments, other suitable reflective layers may be provided from other suitable materials. Whereas reflective layer 32 reflects radiant energy, the high density layers prevent air or water vapor from passing there through. As an alternate embodiment, an insulating layer may further be provided adhered to the sealing layer 52. For example, layer 38 may comprise an insulating layer made of fiberglass or closed cell foam or other suitable flexible insulating material. Here, the insulating layer insulates heat from being conducted though flexible liner 21 increasing the effective energy efficiency of building 10. In alternate embodiments, more or less insulating, sealing or reflective layers may be provided. In the embodiment shown, flexible liner 21 has a reinforcing layer having first polyester reinforcing layer 42 and second polyester reinforcement layer 44. Flexible liner 21 further has a sealing layer having first high density polyethylene layer 36, second high density polyethylene layer 38 and third high density polyethylene layer 40. Polyester reinforcement layers 42, 44 are bonded to the high density polyethylene layers 36, 38, 40 with first molten polyethylene layer 46 and second molten polyethylene layer 48.

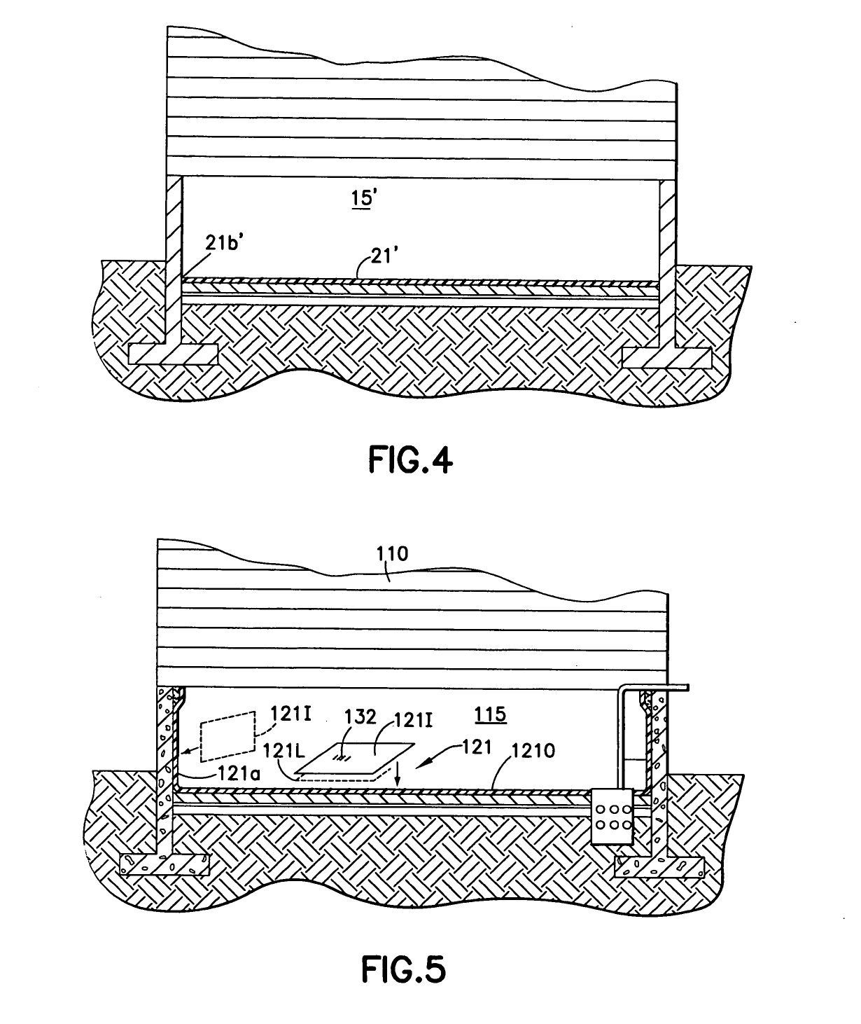

Referring now to FIG. 4, there is shown another section view of a building with a partially subterranean chamber 15′ wherein the sealing system is applied to a portion of the chamber surface in accordance with another exemplary embodiment. The chamber and sealing system shown in FIG. 4 is similar to that described before and shown in FIGS. 1-3. Similar features are similarly numbered. As seen in FIG. 4, in the exemplary embodiment the liner 21′ may be applied to a desired portion of the outer surfaces of the chamber 15′. For example, in FIG. 4, the liner 21′ lines the floor of the chamber. In the example shown, the liner 21′, which is substantially continuous, lines substantially the entire floor of the chamber. In alternate embodiments, the liner may cover a portion of the floor. In other alternate embodiments, the seal liner may be used to line other peripheral surfaces of the chamber. Liner 21′ may be sealed to the lined surface as previously described. For example, the edges of the liner 21′ may be sealed to the supporting surface substantially as shown in FIG. 1. Thus, the lined surface may be isolated from the chamber. Liner 21′ has a radiant barrier 32′. In the exemplary embodiment, the chamber 15′ may be encapsulated, with flexible liner (not shown) also extending along the peripheral walls of the chamber (in a manner similar to that shown in FIG. 1) in addition to the liner 21′ on the floor. Liner 21′, having the radiant barrier 32′, may be disposed to seal those chamber peripheral surfaces where a radiant barrier is desired (e.g. inner surface of the chamber structure that form a substantial thermal radiation sink). The liner (not shown) sealing other peripheral surfaces of the chamber may not include a radiant barrier. Thus, portions of the liner (that is substantially continuous), of the chamber encapsulating system, may have a radiant barrier (similar to barrier 35, 35′) and other portions may not have a radiant barrier. In alternate embodiments, the liner portions of the encapsulating system may be located on the inner surface of the peripheral walls bounding the chamber or any other desired surfaces of the chamber sealed with the encapsulation system liner.

Referring now to FIG. 5, there is shown still another section view of a building 110 with a partially subterranean chamber 115 having a sealing system, applied to the chamber surface(s), incorporating features in accordance with still another exemplary embodiment. The chamber and sealing system shown in FIG. 5 is generally similar to the systems described before and shown in FIGS. 1-4, and similar features are similarly numbered. In the exemplary embodiment shown in FIG. 5, the liner system 121 applied to the chamber surface(s) may include multiple liner layers, one or more of which may be applied independently from other liner layers as will be described further below. As seen in FIG. 5, the liner system 121 in the exemplary embodiment, may include an outer liner layer 121O and an inner liner layer 121I. If desired, the liner system 121 may optionally include one or more intermediate liner layers 121L (illustrated in phantom in FIG. 5). As seen in FIG. 5, the outer layer 121O of the liner system 121 is located on the outside of the liner system. When installed in the chamber, the outer liner 121O may be applied onto the chamber surface(s). In the exemplary embodiment, the outer liner 121O may be generally similar to liner 21, 21′, described before, except in this embodiment outer liner 121O may not have an integral radiant barrier layer. Thus, for example, outer liner 121O may be a durable, flexible liner with an impermeable membrane or seal barrier capable of sealing the chamber peripheral surface from the chamber interior. The outer liner 121O may be substantially continuous over the chamber surface(s) covered by the outer liner. The outer liner 121O, in the exemplary embodiment shown in FIG. 5, may have generally vertical or upward portions covering and sealing the wall surface(s) of the chamber. The outer liner may cover all contiguous wall and floor surfaces of the chamber. In alternate embodiments, the outer liner may be applied to seal desired portions of the chamber surface(s) (e.g. the floor, or one or more inner surfaces of the walls) while leaving other chamber surface(s) uncovered by the outer liner. The edges of the outer liner may be sealed to the chamber surfaces as described before. Another suitable example of a liner, that may be used as an outer liner 121O, is described in U.S. Pat. No. 6,575,666, previously incorporated by reference herein in its entirety. In other alternate embodiments, the outer liner may be of any suitable type or composition having at least an impermeable membrane or seal barrier. For example, the outer layer may be but a single unitary construction layer of material (such as plastic) forming the seal barrier.

As noted before, the inner layer 121I is located inside (relative to the chamber) the outer layer 121O. In the exemplary embodiment shown in FIG. 5, the inner layer 121I is the inner most layer of the sealing system 121 for example purposes. In alternate embodiments, further inner layers may be disposed inside of the inner layer. In the exemplary embodiment, the inner layer 121I has a radiant barrier 132. The inner layer 121I may have any desired construction. For example, the inner layer 121I may include a backing or sublayer (not shown) of any suitable material, such as plastic, inorganic or organic fiber weave layer, paper, metallic foil, capable of providing the inner layer with desired mechanical properties. The radiant barrier 132, which may be similar to radiant barrier 32 described before, maybe disposed on the backing in any desired manner so that the inner layer 121I has an integral radiant barrier. In alternate embodiments, the inner layer may have still more layers, such as a layer(s) of insulative material such as foam, or bubble wrap. In still other alternate embodiments, the backing may include an integral insulative material. As seen in FIG. 5, in this exemplary embodiment the layers 121O, 121I of the sealing system 121 may be applied to the chamber surfaces separately and independent of one another. For example, the outer layer 121O may be installed to seal the peripheral surfaces of chamber 15 as shown in FIG. 5. As noted before, in the exemplary embodiment shown in FIG. 5, the outer layer is applied to the chamber surface to encapsulate the chamber, and isolate its interior from the floor and wall surfaces in a manner substantially similar to that described in U.S. Pat. No. 6,575,666 previously incorporated by reference herein. In alternate embodiments, the outer or seal layer may not cover all outer peripheral chamber surfaces. The inner liner 121I may be applied separately to the chamber surfaces from the outer liner. As seen in FIG. 5, the inner liner 121I may be applied over outer liner 1210 covered surfaces if desired. As may be realized, the inner liner 121I may be selectively applied over desired portions of the outer liner covered surfaces. For example, it may be desired to apply the inner liner 121I over the floor or a portion thereof (covered as described before with outer liner 1210) of the chamber, but not the walls. In alternate embodiments, the inner liner may be applied to one or more wall(s) of the chamber. Thus, the inner peripheral surface(s) of the chamber may be covered with the inner liner in any desired combination. Upon application, the inner liner 121I may be attached to the outer liner 121O by any suitable means such as adhesive or adhesive tape. The inner liner 121I is shown with the radiant barrier/surface inside, but in alternate embodiments, the inner liner may be placed with the radiant barrier outside. In still other embodiments, the inner liner may be applied to peripheral surface(s) of the chamber not covered by the outer layer. As seen in FIG. 5, one or more intermediate layers 121L may be installed between inner and outer liners. The intermediate layers may be of any desired type such as insulation layers, reinforcement layers, etc. If desired, no intermediate layers may be placed between outer and inner layers of system 121. In other alternate embodiments, additional inner liners may be applied to cover the inner/radiant barrier liner. As may be realized, system 121 allows the distribution of the system liners around the chamber surface(s) to be optimized for expected conditions. Thus, wet surfaces that are also a thermal radiation sink or source are isolated from the chamber interior by the outer liner and inner liner, while wet surface(s) that may not present a thermal radiation sink/source may be sealed with only the outer liner but no inner liner, and dry surface(s) that are a thermal radiation sink/source may be covered with only the inner liner.

It should be understood that the foregoing description is only illustrative of the invention. Various alternatives and modifications can be devised by those skilled in the art without departing from the invention. Accordingly, the present invention is intended to embrace this and all such alternatives, modifications and variances which fall within the scope of the appended claims.

What is claimed is:

1. A partially subterranean chamber sealing system for sealing at least a partially subterranean chamber of a building, the system comprising:
a flexible liner disposed on at least a portion of a surface bounding the chamber for forming a seal boundary of the chamber, the liner having a peripheral edge sealed to the surface lined by the liner for isolating the surface from the chamber; and
the flexible liner comprising a sealing layer and a radiant barrier disposed on the sealing layer.

2. The partially subterranean chamber sealing system of claim 1, wherein the flexible liner substantially conforms to the surface of the chamber, and wherein the sealing layer is adapted to prevent air, water or vapor from passing there through, and wherein the radiant barrier is adapted to reflect heat radiated thereon.

3. The partially subterranean chamber sealing system of claim 1, wherein the surface is a floor surface.

4. The partially subterranean chamber sealing system of claim 1, wherein the surface is an inner surface of a peripheral foundation wall.

5. The partially subterranean chamber sealing system of claim 1, wherein the chamber is at least one of a crawlspace or a basement.

6. The partially subterranean chamber sealing system of claim 1, wherein the flexible liner is a substantially continuously sealed liner lining peripheral foundation walls and floor bounding the chamber, and wherein the sealed edge is located proximate the top of the peripheral walls.

7. The partially subterranean chamber sealing system of claim 1, wherein the radiant barrier comprises laminate of metal foil metallized or adhered to the sealing layer.

8. The partially subterranean chamber sealing system of claim 1, wherein the flexible liner further comprises an insulating layer.

9. The partially subterranean chamber sealing system of claim 1, wherein the flexible liner further comprises a reinforcing layer having a polyester reinforcement layer, and wherein the sealing layer comprises a high density polyethylene layer, and wherein the sealing layer is bonded to the reinforcing layer with molten polyethylene layer.

10. A partially subterranean chamber sealing system for sealing at least a partially subterranean chamber of a building comprising:
a flexible liner having first and second high density layers;
a reinforcing layer disposed between the first and the second high density layers;
a bonding layer disposed between the first and the second high density layers; and
a reflective layer adhered to either the first or second high density layers;
wherein, the flexible liner is durable to repeatedly support a user walking or crawling thereon without tearing or breaking through the flexible liner, and wherein the bonding layer bonds the first and second high density layers together with the reinforcing layer disposed there between, and wherein the high density layers are adapted to prevent air or water vapor from passing there through, and wherein the reflective layer is adapted to reflect heat radiated thereon.

11. The partially subterranean chamber sealing system of claim 10, wherein the reflective layer comprises a laminate of metal foil either metallized or adhered to either the first or second high density layers.

12. The partially subterranean chamber sealing system of claim 10, wherein the flexible liner further comprises an insulating layer adhered to either the first or second high density layers, wherein the insulating layer insulates heat from being conducted though the flexible liner.

13. The partially subterranean chamber sealing system of claim 10, wherein the reinforcing layer comprises first and second polyester reinforcement layers, and wherein the first and second high density layers comprise first and second high density polyethylene layers, and wherein the flexible liner further comprises a third high density polyethylene layer, and wherein the bonding layer comprises first and second molten polyethylene layers, and wherein the polyester reinforcement layers are bonded to the high density polyethylene layers with the first and second molten polyethylene layers.

14. A partially subterranean chamber sealing system for sealing at least a partially subterranean chamber of a building comprising:
a seal barrier disposed on at least a portion of the chamber for forming a sealed chamber, the seal barrier comprising a sealing layer and being flexible and conformal in shape so as to substantially conform to an uneven floor or wall of the chamber;
a seal disposed between at least a portion of the seal barrier and at least a portion of the chamber, the seal adapted to seal the seal barrier to the chamber; and
a radiant barrier connected to the seal barrier;
wherein, the seal is adapted to prevent air or water vapor from passing there by, and wherein the seal barrier is adapted to prevent air, water or vapor from passing there through, and wherein the radiant barrier is adapted to reflect a substantial portion of radiated heat.

15. The partially subterranean chamber sealing system of claim 14, wherein the radiant barrier comprises a laminate of metal foil adhered to the sealing layer.

16. The partially subterranean chamber sealing system of claim 14, wherein the radiant barrier is metallized to the sealing layer.

17. The partially subterranean chamber sealing system of claim 14 further comprising at least one of a reinforcement layer or an insulating layer adhered to the sealing layer, wherein the insulating layer insulates heat from being conducted though the seal barrier, and the reinforcement layer reinforces the seal barrier to repeatedly support a user walking or crawling thereon without tearing or breaking through the seal barrier.

18. The partially subterranean chamber sealing system of claim 14, wherein the reinforcement layer comprises first and second polyester reinforcement layers, and wherein the sealing layer comprises first, second and third high density polyethylene layers, and wherein the polyester reinforcement layers are bonded to the high density polyethylene layers with first and second molten polyethylene layers.

19. The system of claim 14, wherein the seal barrier is adapted to be supported by the uneven floor surface, and wherein the seal barrier has a peripheral edge portion sealed on a wall portion of the chamber offset from the floor.

20. The system of claim 14, wherein the radiant barrier is adapted to be placed on the seal barrier when the seal barrier is disposed on at least a portion of the chamber.
